(19) United States
(12) Patent Application Publication
(10) Pub. No.: US 2026/0140040 A1
(43) Pub. Date: May 21, 2026

(54) CORROSION MODELING FOR LIFETIME ESTIMATION OF ELECTRONIC COMPONENTS

(71) Applicant: Schneider Electric USA, Inc., Boston, MA (US)

(72) Inventors: Michel Romero Flores, Monterrey (MX); José Carlos Suárez Guevava, San Pedro Garza Garcia (MX)

(21) Appl. No.: 19/205,509

(22) Filed: May 12, 2025

Related U.S. Application Data
(60) Provisional application No. 63/722,425, filed on Nov. 19, 2024.

(51) Int. Cl. G01N 17/00

(52) U.S. Cl. CPC G01N 17/006; G01N 17/002

(57) ABSTRACT

A system for monitoring corrosion-induced degradation of electronic devices. A modeling processor generates a model of the physical characteristics of an electronic device. The modeling processor generates and validates a complex model of the localized effect of corrosion on the electronic device. The modeling processor then generates a reduced order model based on the complex model. A corrosion monitor processor receives sensor measurements within a cabinet associated with the electronic device. The corrosion monitor processor executes the reduced order model based on the physical characteristics of the electronic device and the sensor measurements to generate a predicted corrosion rate. The corrosion monitor generates an expected lifetime of the electronic device based on the corrosion rates and provides alerts based on expected remaining lifetime.

### CROSS-REFERENCE TO RELATED APPLICATION

This application claims priority to U.S. Provisional Patent Application No. 63/722,425, filed Nov. 19, 2024, the entire disclosure of which is incorporated herein by reference.

### BACKGROUND

Electronic devices, the foundation of modern life, are constantly

exposed to environmental stressors. Corrosion is a prevalent degradation mechanism that can significantly shorten the lifespan of electronic devices, leading to malfunctions and costly failures. According to recent estimates, corrosion-induced costs within the electronics industry amount to 2.5 trillion of dollars annually. Understanding and predicting corrosion behavior is crucial for ensuring the reliability and durability of electronic systems.

Corrosion poses a serious threat to the reliability and longevity of different electronic devices containing Printed Circuit Boards (PCBs). Understanding and predicting corrosion processes are critical to designing and maintaining robust electronics. Moreover, corrosion may significantly increase process costs. For example, if a critical electronic component of a process fails because of corrosion, it may produce a series of problems that may lead to total process shutdown. So, this may produce incremented production costs and waste production because of necessary repairs. Traditional experimental approaches to evaluate corrosion can be limited by time, cost, and the difficulty of replicating complex real-world environments.

### SUMMARY

Aspects of the present disclosure disclose a system for monitoring corrosion-induced degradation of an electronic device. Using multiphysics simulations a complex model of corrosion induced degradation based on the physical characteristics of the electronic device and sensor measurement information. The complex model is validated based on corrosion information of previous electronic devices. Then, a reduced order model based on the complex model is created. This reduced order model is introduced into a corrosion monitor processor, which receives sensor measurements from sensors within a cabinet of the electronic device. The corrosion monitor processor executes the reduced order model based on the sensor measurements. The corrosion monitor processor predicts the effect of corrosion on the electronic device to determine its expected lifetime. The corrosion monitor processor provides alerts based on the expected lifetime of the electronic device when reaching preconfigured thresholds.

In an aspect, a system for monitoring corrosion-induced degradation of electronic devices includes a housing, an electronic device within the housing, and one or more sensors within the housing. The sensors generate one or more environmental measurements indicating an environmental condition within the housing. The system also includes a corrosion monitor processor electronically coupled to the sensors and a memory coupled to the corrosion monitor processor. When executed by the corrosion monitor processor, computer-executable instructions stored in the memory configure the corrosion monitor processor for receiving specification information associated with the electronic device and generating a model of one or more physical characteristics of the electronic device based on the specification information. The executable instructions further configure the corrosion monitor processor for receiving, from the sensors, the environmental measurements generated thereby and executing a reduced order physics-based model based on the specification information, the model of the physical characteristics of the electronic device, and the environmental measurements to generate a predicted corrosive effect on the electronic device. The executable instructions also configure the wear-leveling processor for determining a corrosion rate based on the predicted corrosive effect.

In another aspect, a system for monitoring corrosion-induced degradation of electronic devices includes a cabinet, an electronic device located within the cabinet, a temperature sensor associated with electronic device and configured for measuring a temperature within the cabinet, and a corrosive contaminant concentration sensor associated with the electronic device and configured for measuring a concentration of corrosive contaminants within the cabinet. The system further includes a corrosion monitor processor electronically coupled to the temperature sensor and the corrosive contaminant concentration sensor and a memory coupled to the corrosion monitor processor. The memory stores processor-executable instructions that, when executed, configure the corrosion monitor processor for receiving specification information associated with the electronic device and generating a model of one or more physical characteristics of the electronic device based on the specification information. The processor-executable instructions also include receiving a temperature measurement from the temperature sensor, the temperature measurement indicative of a temperature within the cabinet and receiving one or more corrosive concentration measurements from the corrosive contaminant concentration sensor, the corrosive concentration measurements indicative of at least one corrosion concentration of one or more atmospheric corrosive contaminants within the cabinet. The processor-executable instructions further include executing a mathematical model based on the specification information, the model of the physical characteristics of the electronic device, the temperature measurement, and the corrosive concentration measurements to generate a predicted corrosion rate and determining an expected remaining lifetime of the electronic device based on the predicted corrosion rate.

In yet another aspect, a method of modeling corrosion-induced degradation of electronic devices includes receiving specification information associated with an electronic device and obtaining a temperature measurement, from a temperature sensor within a cabinet housing the electronic device, the temperature measurement indicative of a temperature within the cabinet. The method further includes obtaining at least one corrosive concentration measurement, from a corrosive concentration sensor within the cabinet, the corrosive concentration measurement indicative of a concentration of one or more atmospheric corrosive contaminants within the cabinet and executing a mathematical model based on the specification information, the temperature measurement, and the corrosive concentration measurements to generate a corrosion rate prediction of the electronic device.

In other aspects, a method to prevent outages in an industrial system resulting from corrosion-induced degradation in one or more electronic devices includes receiving, on a corrosion monitoring system, a model of one or more physical characteristics of the electronic devices and obtaining one or more environmental measurements indicating an environmental condition within a housing associated with the electronic devices. The method further includes executing, by the corrosion monitoring system, a reduced order physics-based model based on the model of the physical characteristics of the electronic devices and the environmental measurements to generate a predicted corrosive effect on the electronic devices and determining a corrosion rate based on the predicted corrosive effect. The method also includes transmitting, to a display coupled to the corrosion monitoring system, a graphical representation of the corrosion rate and the predicted corrosive effect to identify an expected lifetime of the electronic devices and identifying a maintenance window to replace at least one of the electronic devices based on the expected lifetime of the electronic devices. The method additionally includes replacing at least one of the electronic devices during the maintenance window.

Other objects and features of the present invention will be in part apparent and in part pointed out herein.

### BRIEF DESCRIPTION OF THE DRAWINGS

FIG. 1 is a block diagram illustrating a system for monitoring

corrosion-induced degradation of an electronic device according to an embodiment.

FIG. 2 is a flow diagram illustrating a process for generating a reduced order model for predicting corrosion-induced degradation of an electronic device according to an embodiment.

FIG. 3A illustrates a detailed model of a simplified conductive path on an electronic device based on the physical characteristics of the electronic device according to an embodiment.

FIG. 3B illustrates a detailed model of an effect of corrosion-induced degradation of a simplified conductive path of an electronic device according to an embodiment.

FIG. 4 is a flow diagram illustrating a process for monitoring the corrosion-induced degradation of an electronic device according to an embodiment.

FIG. 5 illustrates an example output of the process of FIG. 4 according to an embodiment.

FIG. 6 illustrates an example graphical output of the expected lifetime prediction according to an embodiment.

FIG. 7 is a block diagram illustrating a computer system according to an embodiment.

Corresponding reference characters indicate corresponding parts throughout the drawings.

### DETAILED DESCRIPTION

The features and other details of the concepts, systems, and

techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

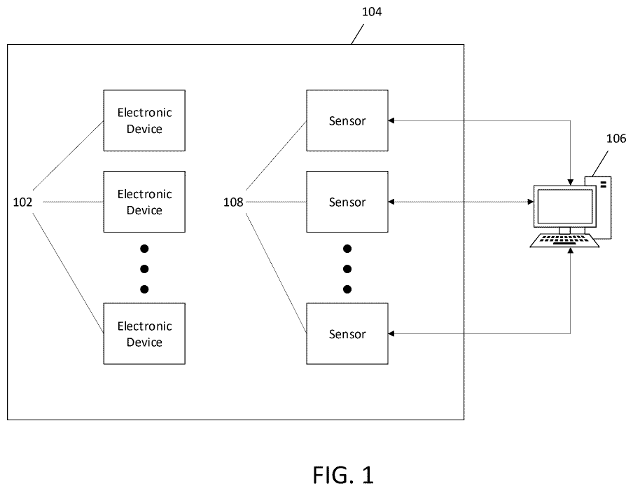

FIG. 1 is a block diagram illustrating a system 100 for monitoring corrosion-induced degradation of electronic devices according to an embodiment. The monitoring system may monitor the corrosive effect on one or more electronic devices 102 within a single housing or cabinet 104. The electronic device 102 may be any electronic device in a corrosive environment. For example, the electronic device 102 may include a printed circuit board assembly (PCBA) of an industrial control device such as a programmable automation controller (PAC), a remote terminal unit (RTU), a programmable logic controller (PLC), an intelligent electronic device (IED) or another device for use in an industrial automation and control system (IACS), a distributed control system (DCS), a supervisory control and data acquisition (SCADA) system, or the like. Electronic device 102 may also include electronic devices such as sensors, robotics, or any other machinery of the industrial process.

In some embodiments, the electronic device 102 is one of multiple electronic devices within a single housing or cabinet 104 of an industrial device. In other embodiments, the electronic device 102 of one industrial device resides in a housing or cabinet 104 with multiple other electronic devices. For example, a single industrial device may include a single PCBA within a housing or alternatively, several PCBAs for performing different functions within a single housing. Because industrial devices often reside in operating plants or environments with potentially high levels of corrosive contaminants, the electronic devices 102 of the industrial device are susceptible to corrosion degradation. As a result, numerical modeling and simulations are desired as a powerful complement and for enabling controlled analysis of corrosion mechanisms and the impact of numerous influential factors.

As shown in FIG. 1, the corrosion monitoring system 100 includes a corrosion monitor processor 106. The corrosion monitoring processor 106 monitors corrosion within an environment such as a cabinet or housing 104, described further below. In one embodiment, the corrosion monitor processor 106 may be a control device of the industrial process described above. In other embodiments, the corrosion monitor processor 106 may be a monitoring device outside the monitored environment. In some embodiments, the corrosion monitor processor 106 couples with input and output devices such as a keyboard, mouse, displays, and/or microphone for inputting information to the processor 106. In one or more embodiments, the corrosion monitor processor 106 includes an interactive software for presenting information related to monitoring the corrosive-degradation of the electronic device 102. In other embodiments, the corrosion monitor processor 106 couples over a network to a separate monitoring system or a cloud service providing monitoring information to users or operators of an industrial plant.

Still referring to FIG. 1, the corrosion monitor processor 106 electronically couples to one or more sensors 108 within the housing or cabinet 104. The sensors 108 monitor environmental conditions within the housing or cabinet 104. Thus, the sensors 108 are associated with the electronic device 102 by capturing information of the environment in which the electronic device 102 resides. The rate of corrosion for a metallic material varies based on environmental conditions such as humidity, temperature, and concentration of potential contaminants in the air. As a result, sensors 108 include a temperature sensor, such as one or more thermocouples or resistance temperature detectors; a humidity sensor such as a humidity concentration detector for measuring a humidity concentration within the housing 104; and a corrosive contaminant concentration sensor for measuring atmospheric corrosive contaminant concentration. In other embodiments, the sensors 108 include a corrosion concentration sensor for measuring the corrosion on the electronic device.

Each industrial plant or facility may have different individual contaminants and the level of contaminants may differ depending on location within the plant. For this reason, generalized monitoring fails to provide the real corrosive degradation effect on electronic device 102. Each plant may have its own set of contaminants which induce corrosion based on chemicals within the plant, with some featuring higher concentrations of a wider variety of contaminants. Further, the concentration of a given contaminant may vary within the environment such that the concentration could be higher or lower outside the cabinet or housing 104 in which the electronic device 102 resides. Accurate measurement through sensors 108 in close proximity to the electronic device 102 ensures optimal failure detection and without excessive cost. For example, if sensors 108 were instead monitoring the environment outside (rather than inside, as shown in FIG. 1) the cabinet 104, and if the external environment presents a higher concentration of contamination, the corrosion monitor processor 106 will predict an earlier failure than reality. As a result, the electronic device 102 would be replaced more frequently than it should, increasing cost for operation of the facility and increasing maintenance windows. In contrast, if the external environment presents a lower concentration of contamination, the corrosion monitor processor 106 will fail to accurately predict the time to failure. The predicted time to failure will be further in the future than the reality based on the electronic device's 102 environment. Therefore, the facility will have an unexpected downtime due to the failure of the electronic device 102 during regular operations.

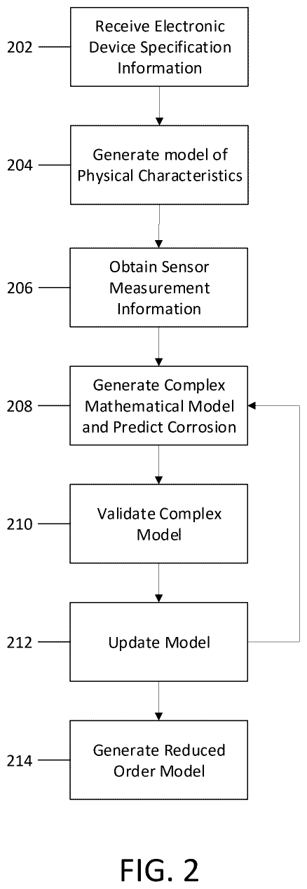

FIG. 2 is a flow diagram illustrating the process for creating a reduced order model for monitoring corrosion-induced degradation according to an embodiment. In some embodiments, the mathematical modeling is performed by a modeling processor separate from the corrosion monitor processor 106 to meet the higher computational needs for generating a complex mathematical model of corrosion. In some embodiments, the reduced order model is generated and uploaded to the corrosion monitor processor before installing the corrosion monitor processor and/or sensors within the cabinet. The modeling process may be embodied by the corrosion monitoring processor 106 of FIG. 1. In one or more embodiments, the corrosion monitor processor 106 acts as the modeling processor and performs the complex modeling. A modeling processor receives electronic device 102 specification information at step 202. The specification information provides information about the electronic device 102 including physical design characteristics and as well as operating characteristics. The specification information may include the physical property of the board and materials, electrical specification (voltage, amperage, resistivity, etc.), and geometric layout of the components on the circuit board and conductive paths. Physical properties of the board include the materials of the board, the thickness of copper within the board, the type of coating material, the coating thickness, the layer count of the board, and any other physical material property information associated with the board. The specification information also includes information about the location of the device within a cabinet or housing 104 and/or within the monitored environment generally.

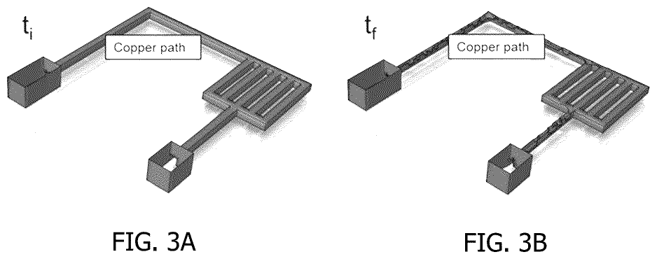

Continuing with FIG. 2, the corrosion monitor processor 106 generates a model of the physical characteristics of the electronic device 102 at step 204. FIG. 3A illustrates an example model of the physical characteristics of an electronic device 102. As can be seen, the model of the physical characteristics shows the geometric layout of the electronic device 102 and the components of its printed circuit board with circuit traces. Using the specification information of the electronic device 102, the corrosion monitor processor 106 creates a digital representation of the physical characteristics. The digital model enables accurate prediction of the effect of corrosion-induced degradation based on the physical materials and layout of the circuit board of the electronic device 102.

After generating the model of the physical characteristics, sensor information is collected at step 206 of FIG. 2. In one or more embodiments, mathematical modeling of the corrosion-induced degradation occurs before installation of the electronic device 102, thus the collection of sensor data from previously installed devices of the same model. In one embodiment, during initial development of the model, sensor information may include previous sensor measurement information collected from a system with the electronic device 102 installed. Sensor information includes temperature measurements, humidity concentration measurements, and contaminant concentration measurements.

As illustrated in FIG. 2, at step 208, a modeling processor performs complex modeling of the effect of corrosion on the model of the physical characteristics. The modeling processor generates a complex physics-based model based on the entirety of the system including voltage, current, temperature, humidity, contaminant concentration, geometry, etc. A computational method such as Finite Volume Modeling may be used to assess the distribution of corrosion rate and electrochemical potentials across complex electronic device geometries. Through a complex model of the corrosion process, the modeling processor fully predicts the localized effect of corrosion on the electronic device 102 as a function of time. In some embodiments, the modeling includes a calculation of a reaction rate for the metallic components of the electronic device 102 according to the Arrhenius equation. In other embodiments, the modeling applies any other reaction rate model for predicting the effect of corrosion. In one or more embodiments, the complex model includes thermal and fluidic 3D modeling for predicting the effects of humidity and temperature on corrosion rate.

Still referring to FIG. 2 at step 210, the complex model of the effect of corrosion is validated. The complex model is validated against real world corrosion data of the effect of corrosion on the electronic device 102. For example, the real world corrosion data may be gathered based on usage of the electronic device 102 within other facilities. To validate the complex model, the modeling processor generates a predicted localized effect of corrosion-induced degradation based on the model of the physical characteristics and historical sensor information. FIG. 3B illustrates a prediction of the localized effect of corrosion on the electronic device 102 showing several points on the copper path where the path is degraded. After generating a prediction, the prediction is compared to the real-world result of corrosion induced degradation.

At step 212, the complex physics-based model may be updated based on comparison of the predicted effect of corrosion to the real world corrosion data. Following the updates to the model, corrosion monitor processor 106 creates a new predicted localized effect of corrosion according to step 208, and the model is once again validated at step 210. After successful validation of a complex model, a simplified reduced order model is generated at step 214. A reduced order model enables the corrosion monitor processor 106 to perform persistent monitoring of corrosion through information collected from sensors 108 without a high computational cost. In some embodiments, if the original reaction rate was based on the Arrhenius equation, the simplifying the model results in a reduced order model of the Arrhenius equation. Further, the reduced order model enables monitoring of corrosion using a less computationally powerful processor of the industrial automation management system.

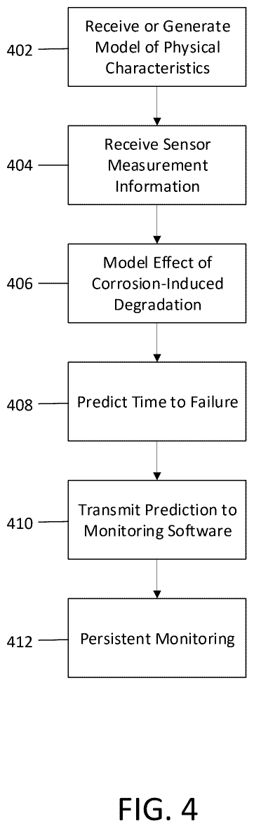

FIG. 4 is a flow diagram of a process of monitoring an electronic device 102 in an industrial automation system. At step 402, the corrosion monitor processor 106 receives or generates a model of the physical characteristics of the electronic device 102. In some embodiments, the corrosion monitor processor 106 receives the model of physical characteristics generated during step 204 of FIG. 2. In other embodiments, the corrosion monitor processor 106 generates a model of the physical characteristics of the electronic device 102 based on specification information according to steps 202 and 204 of FIG. 2.

At step 404 of FIG. 4, the corrosion monitor processor 106 receives sensor measurement information. The sensor measurement information includes real-time measurements obtained by sensors 108 within the cabinet or housing 104 of the electronic device 102. The sensor information collected in real-time includes temperature measurements, humidity concentration measurements, and corrosive contaminant concentration measurements. In some embodiments, the corrosion monitor processor 106 also receives an input from a user indicating expected contaminants in the environment of the electronic device 102. By receiving a set list of contaminants, the modeling of corrosion can be simplified. Rather than modeling for any and all contaminants potentially present within an environment, the corrosion monitor processor 106 only models corrosion-induced degradation caused by the input contaminants.

Referring still to FIG. 4, the corrosion monitor processor 106 models the effect of corrosion-induced degradation on the electronic device 102 based on the sensor measurement information at step 406. In some embodiments, the corrosion monitor processor 106 performs modeling of corrosion on a set cadence. For instance, the corrosion monitor processor 106 may model corrosion each hour or nightly based on updated sensor measurement information. In other embodiments, a user of the interactive software executed by the corrosion monitor processor 106 may send an input indicating that the corrosion monitor processor 106 should generate an updated prediction. The corrosion monitor processor 106 uses the reduced order model generated according to step 214 of FIG. 2 to model the effects of corrosion-induced degradation. By utilizing the reduced order model, the corrosion monitor processor 106 provides real-time or near real-time predictions of the effect of corrosion-induced degradation. The corrosion monitor processor 106 models corrosion through applying the localized effect of the corrosion rate to the model of the physical characteristics of the electronic device 102. In some embodiments, if an input of contaminants was received, the corrosion monitor processor 106 models the effect of corrosion-induced degradation of the electronic device 102 only due to those contaminants. By targeting specific contaminants, the corrosion monitor processor 106 more quickly determines the effect of corrosion with little impact to accuracy.

Continuing with FIG. 4 at step 408, the corrosion monitor processor 106 generates a predicted time to failure for the electronic device 102. Utilizing the modeled corrosive effect of corrosion on the electronic device, the corrosion monitor processor 106 identifies the first connection failure of the electronic device 102. The first failure of the electronic device occurs when a conductive path of the circuit board severs, thus creating an open circuit preventing electrical communication within the electronic device. The corrosion monitor processor 106 then determines the time to failure based on the corrosion rate as applied locally to the failure location. After generation of the predicted time to failure, the corrosion monitor processor 106 transmits to the interactive monitoring software and/or a display coupled to the corrosion monitor processor 106 the predicted failure time of the electronic device 102 at step 410.

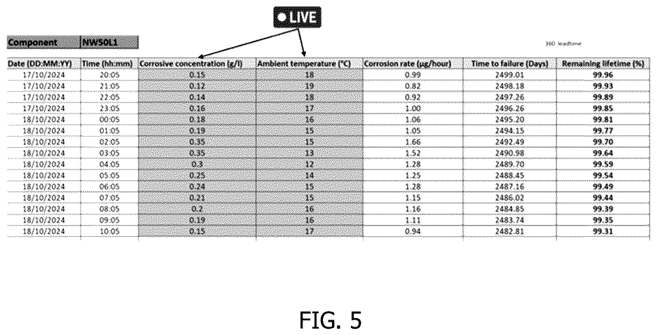

After generating the predicted time to failure, the corrosion monitor processor 106 performs persistent monitoring and alerting in response to new sensor measurement information at step 412 of FIG. 4. As described in step 406, the corrosion monitor may model the corrosion-induced degradation of the electronic device 102 at a set cadence. As a result, after presenting the initial prediction for time to failure of the electronic device 102, the corrosion monitor processor 106 provides regular monitoring and updates. Thus, the corrosion monitor processor 106 receives an updated temperature measurement and an updated corrosion concentration measurement. Using these measurements, the corrosion monitor processor 106 models a revised corrosion rate and a revised electronic device 102 expected remaining lifetime. FIG. 5 is a table illustrating a prediction of corrosion rate on an electronic device and the related predicted time to failure. As shown in the table, the corrosion monitor processor 106 receives updated measurements of corrosive concentration and temperature to update the predictions.

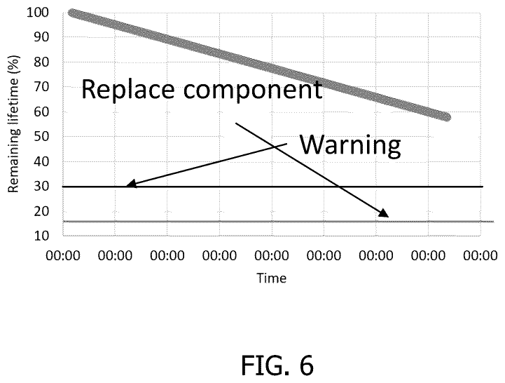

FIG. 6 illustrates an example graphical output of the lifetime prediction for an electronic device 102. The corrosion monitor processor 106 may be configured to provide alerts in response to predetermined events. As shown in FIG. 6, the corrosion monitor processor 106 uses the expected remaining lifetime for the electronic device 102 to determine when to alert a user. When the expected remaining lifetime crosses a threshold, shown here as ten percent, the corrosion monitor processor 106 may generate an alert to send to the interactive monitoring processor or render on the display coupled to the corrosion monitor processor 106. Alternatively, the corrosion monitor processor 106 may generate an alert when the electronic device 102 has only one month or six months remaining on the expected life. Sending alerts at predetermined stages of degradation ensures that no downtime occurs due to a failure. When a device has previously degraded due to corrosion, the device is more susceptible to failures caused by other environmental factors such as vibration causing a severing of a degraded conductive path.

By utilizing the reduced order model generated by the process of FIG. 2, an operator may prevent outages within the industrial system. The corrosion monitoring system 100 performs persistent monitoring of electronic devices 102 by receiving a model of the physical characteristics of the electronic devices 102. Then the corrosion monitoring system 100 obtains the environmental measurements indicating an environmental condition within a housing associated with the electronic devices 102. By executing a reduced order model, based on the physical characteristics of the electronic devices 102 and the environmental measurements, the corrosion monitoring system 100 generates a predicted corrosive effect on the electronic devices 102. Then the corrosion monitoring system 100 determines a corrosion rate based on the predicted corrosive effect and transmits a graphical representation of the corrosion rate and the predicted corrosive effect to render on a display coupled to the monitoring system 100. Then an operator may identify an expected lifetime of the electronic devices 102. Then based on the expected lifetime, the operator may determine a maintenance window for replacing at least one of the electronic devices 102. Then during the maintenance, the operator replaces at least one of the electronic devices 102.

The processes of persistent monitoring and maintenance scheduling also enable an operator to respond to the changing environment. For example, in response to an alert, a user may replace the electronic device 102 before failure during a scheduled maintenance window to ensure maximal uptime for the industrial system. As shown in FIG. 6, a user may opt to replace the electronic device at thirty percent remaining of expected lifetime to preemptively avoid any downtime due to failure. Additionally, if the corrosion monitor processor 106 monitors multiple electronic devices within a single cabinet 104, the user can determine an optimal time or times to perform maintenance for multiple electronic devices based on the expected failure time for all monitored devices. Because all electronic devices 102 within a given cabinet or housing 104 experience similar effects of the environment, all device may have a similar time to failure. Using the predicted time to failure for each electronic device 102, a user can identify when one device is approaching failure whether other devices also need replacement due to a similar failure time. As a result, the number of maintenance windows for replacing electronic devices 102 may be limited.

Embodiments of the present disclosure may comprise a special purpose computer including a variety of computer hardware, as described in greater detail herein.

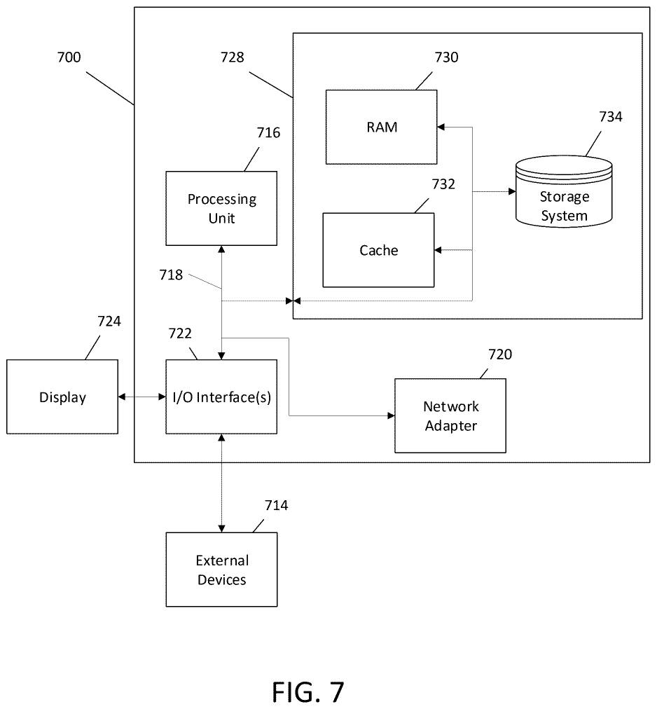

Computer system 700 is shown in FIG. 7 in the form of a general-purpose computing device which may act as the corrosion monitor processor 106. The components of computer system 700 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 700 typically includes a variety of computer system readable media. Such media may be any available media that is accessible by computer system 700, and it includes both volatile and non-volatile media, removable and non-removable media.

System memory 728 can include computer system readable media in the form of volatile memory, such as random-access memory (RAM) 730 and/or cache memory 732. Computer system 700 may further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 may include at least one program product having a set (e.g., at least one) of program modules that are configured to carry out the functions of embodiments of the disclosure.

Computer system 700 may also communicate with one or more external devices 714 such as a keyboard, a pointing device, a display 724, etc.; one or more devices that enable a user to interact with computer system 700; and/or any devices (e.g., network card, modem, etc.) that enable computer system 700 to communicate with one or more other computing devices. Such communication can occur via Input/Output (I/O) interfaces 722. Still yet, computer system 700 can communicate with one or more networks such as a LAN, a general WAN, and/or a public network (e.g., the Internet) via network adapter 720. As depicted, network adapter 720 communicates with the other components of a network (not shown) via bus 718. It should be understood that although not shown, other hardware and/or software components could be used in conjunction with computer system 700. Examples, include, but are not limited to: microcode, device drivers, redundant processing units, external disk drive arrays, RAID systems, tape drives, and data archival storage systems, and so on.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A system for monitoring corrosion-induced degradation of electronic devices, the system comprising:
a housing;
an electronic device within the housing;
one or more sensors within the housing, the one or more sensors configured to generate one or more environmental measurements indicating an environmental condition within the housing;
a corrosion monitor processor electrically coupled to the sensors;
a memory coupled to the corrosion monitor processor, the memory storing processor-executable instructions that, when executed, configure the corrosion monitor processor for:
receiving specification information associated with the electronic device;
loading a model based on one or more characteristics of the
specification information associated with the electronic device;
receiving, from the one or more sensors, the environmental measurements generated thereby;
executing a reduced order physics-based model based on the specification information, the model of the physical
characteristics of the electronic device, and the environmental measurements to generate a predicted corrosive effect on the electronic device; and
determining a corrosion rate based on the predicted corrosive effect.

2. The system of claim 1, wherein the one or more sensors comprise at least one of a temperature sensor indicating a temperature within the housing, a corrosive contaminant concentration sensor indicating a concentration of at least one atmospheric corrosive contaminant within the housing, or a humidity concentration detector indicating a humidity concentration within the housing.

3. The system of claim 1, wherein the reduced order physics-based model comprises a reduced order model based on a complex model created using at least one of an Arrhenius equation for predicting a reaction rate, a thermal model for predicting a temperature effect on corrosion, or a fluidic 3D model for predicting a humidity effect on corrosion.

4. The system of claim 1, wherein the memory stores processor-executable instructions that, when executed, further configure the corrosion monitor processor for generating a predicted electronic device lifetime based on a time to first connection failure of the electronic device due to the corrosion rate.

5. A system for monitoring corrosion-induced degradation of electronic devices, the system comprising:
a cabinet;
an electronic device located within the cabinet;
a temperature sensor associated with electronic device and configured for measuring a temperature within the cabinet;
a corrosive contaminant concentration sensor associated with the electronic device and configured for measuring a concentration of corrosive contaminants within the cabinet;
a corrosion monitor processor electrically coupled to the temperature sensor and the corrosive contaminant concentration sensor;
a memory coupled to the corrosion monitor processor, the memory storing processor-executable instructions that, when executed, configure the corrosion monitor processor for:
receiving specification information associated with the electronic device;
loading a model based on one or more physical characteristics of the specification information associated with the electronic device;
receiving a temperature measurement from the temperature sensor, the temperature measurement indicative of a temperature within the cabinet;
receiving one or more corrosive concentration measurements from the corrosive contaminant concentration sensor, the corrosive concentration measurements indicative of at least one corrosion concentration of one or more atmospheric corrosive contaminants within the cabinet;
executing a physics-based model based on the specification information, the model of the physical characteristics of the electronic device, the temperature measurement, and the corrosive concentration measurements to generate a predicted corrosion rate; and
determining an expected remaining lifetime of the electronic device based on the predicted corrosion rate.

6. The system of claim 5, the system further comprising a display coupled to the corrosion monitor processor and wherein the memory stores processor-executable instructions that, when executed, further configure the corrosion monitor processor for:
rendering, on the display, the determined electronic device expected remaining lifetime; and
generating on the display, in response to the determined electronic device expected remaining lifetime falling below a threshold of a total expected lifetime of the electronic device, an alert to replace the electronic device.

7. The system of claim 5, the system further comprising a humidity concentration detector associated with the electronic device and configured to measure a humidity within the cabinet, and wherein the memory stores processor-executable instructions that, when executed, further configure the corrosion monitor processor for:
receiving a humidity concentration measurement from the humidity concentration detector, the humidity concentration measurement indicative of a humidity concentration within the cabinet; and
wherein executing the physics-based model is further based on the humidity concentration.

8. The system of claim 5, wherein the memory stores processor-executable instructions that, when executed, further configure the corrosion monitor processor for:
receiving an updated temperature measurement from the temperature sensor, the temperature measurement indicative of an updated temperature within the cabinet during operation of the electronic device;
receiving an updated corrosive concentration measurement from the corrosive contaminant concentration sensor, the updated corrosive concentration measurement indicative of an updated corrosion concentration within the cabinet during operation of the electronic device;
modeling a revised corrosion rate of the electronic device based on the model of the physical characteristics of the electronic device, the updated temperature measurement, and the updated corrosive concentration measurement; and
determining a revised electronic device expected remaining lifetime based on the revised corrosion rate.

9. The system of claim 5, wherein the memory stores processor-executable instructions that, when executed, further configure the corrosion monitor processor for receiving, before executing the physics-based model, one or more inputs representative of atmospheric corrosive contaminants to which the electronic devices is expected to be exposed, and wherein the corrosive concentration measurements are indicative of a corrosion concentration of the inputs.

10. The system of claim 5, wherein the memory stores processor-executable instructions that, when executed, further configure the corrosion monitor processor for modeling, using an Arrhenius equation, a corrosion rate of the electronic device based on the model of the physical characteristics of the electronic device, the temperature measurement, and the corrosive concentration measurements.

11. The system of claim 5, wherein the specification information comprises at least one of a geometric layout of the electronic device, a copper thickness, a voltage, an amperage, a resistivity, a coating material, a coating thickness, a layer count, or material property information.

12. The system of claim 5, wherein the memory stores processor-executable instructions that, when executed, further configure the corrosion monitor processor for generating a reduced order model of the physics-based model.

13. The system of claim 5, wherein determining the expected remaining lifetime of the electronic device based on the predicted corrosion rate comprises applying the corrosion rate to the model physical characteristics of the electronic device and calculating a time to a first failure of a connection of the electrical device.

14. A method of modeling corrosion-induced degradation of electronic devices, the method comprising:
receiving, by a corrosion monitor processor, specification information associated with an electronic device;
obtaining, by the corrosion monitor processor, a temperature measurement, from a temperature sensor within a cabinet housing the electronic device, the temperature measurement indicative of a temperature within the cabinet;
obtaining, by the corrosion monitor processor, at least one corrosive concentration measurement, from a corrosive concentration sensor within the cabinet, the corrosive concentration measurement indicative of a concentration of one or more atmospheric corrosive contaminants within the cabinet; and
executing, on the corrosion monitor processor, a physics-based model based on the specification information, the temperature measurement, and the corrosive concentration measurements to generate a corrosion rate prediction of the electronic device.

15. The method of claim 14, further comprising generating an expected remaining lifetime of the electronic device based on the corrosion rate prediction.

16. The method of claim 14, wherein the specification information comprises at least one of a geometric layout of the electronic device, a copper thickness, a voltage, an amperage, a resistivity, a coating material, a coating thickness, a layer count, or material property information.

17. The method of claim 14, further comprising obtaining a humidity concentration measurement, from a humidity concentration detector within the cabinet, the humidity concentration measurement indicative of a humidity concentration within the cabinet and wherein executing the physics-based model is further based on the humidity concentration measurement.

18. The method of claim 14, further comprising:
obtaining an updated temperature measurement on a regular time interval;
obtaining an updated corrosive concentration measurement on the regular time interval; and
executing the physics-based model based on the specification information, the updated temperature measurement, and the updated corrosive concentration measurement to generate a revise corrosion rate of the electronic device.

19. The method of claim 14, wherein the specification information comprises at least one of a geometric layout of the electronic device, a copper thickness, a voltage, an amperage, a resistivity, a coating material, a coating thickness, a layer count, or material property information.

20. The method of claim 14, wherein the physics-based model comprises a reduced order model, and the method further comprises:
generating, on a modeling processor, a complex physics-based model of corrosion based on at least one of a corrosion reaction rate model, a thermal model predicting the effects of temperature on corrosion and a fluidic 3D model for predicting the effects of humidity on corrosion;
validating, on the modeling processor, the complex physics-based model based on real world corrosion data;
creating, on the modeling processor, the reduced order model based on the complex physics-based model; and
loading, on the corrosion monitor processor, the reduced order model.
